(19) United States
(12) Patent Application Publication
(10) Pub. No.: US 2024/0028222 A1
(43) Pub. Date: Jan. 25, 2024

(54) SLEEP MODE USING SHARED MEMORY BETWEEN TWO PROCESSORS OF AN INFORMATION HANDLING SYSTEM

(71) Applicant: Dell Products L.P., Round Rock, TX (US)

(72) Inventors: Shekar Babu Suryanarayana, Bangalore (IN); Daniel L. Hamlin, Round Rock, TX (US)

(73) Assignee: Dell Products L.P., Round Rock, TX (US)

(21) Appl. No.: 17/814,458

(22) Filed: Jul. 22, 2022

(51) Int. Cl. G06F 3/06

(52) U.S. Cl. CPC G06F 3/0625; G06F 3/0631; G06F 3/064; G06F 3/0679

(57) ABSTRACT

An information handling system is provided that utilizes two separate processors in a big-little hybrid configuration and transitions control over certain processes that may be active during sleep mode from the big, or main, processor with higher processing capabilities to the little, or hybrid, processor with greater power efficiency upon sleep mode being triggered. Control of the processes can be transitioned back to the main processor upon sleep mode being terminated. Transitioning control of these processes in this way results in reduced battery drainage compared to typical sleep mode since the provided information handling system performs the background and value adding activities in sleep mode using a processor that has greater power efficiency than which is used in typical sleep mode.

### FIELD OF THE DISCLOSURE

The instant disclosure relates to information handling systems. More specifically, portions of this disclosure relate to a power-efficient sleep mode for information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems can typically operate in a sleep mode (e.g., Modern Standby for Microsoft® operating systems) when not in active use to conserve battery power. Typical sleep mode, however, permits battery-draining background activity, such as system updates and downloads that can result in increased operating temperature and shortened battery life for the information handling system. An information handling system's main CPU is a factor in the platform power consumption. As such, at least part of sleep mode's power consumption results from holding the information handling system's main CPU in an active power mode, or transitioning it to an active power mode from sleep mode to perform the background activities.

### SUMMARY

Aspects of this disclosure provide an information handling system with an improved sleep mode that may provide power reduction beyond conventional sleep modes. The information handling system may use two processors of different configurations, such as in a big-little hybrid configuration. Upon triggering a sleep mode, the information handling system transitions control over some or all processes that may be active during sleep mode from the big, or main, processor configured with higher processing capabilities to the little, or hybrid, processor configured with greater power efficiency. Control of the processes may be transitioned back to the main processor after terminating the sleep mode. Transitioning control of these processes in this way results in reduced battery drainage compared to a typical system's sleep mode because the provided information handling system performs background and functional activities (e.g., connectivity operations such as transmitting messages, e-mails, and location updates) during sleep mode using a processor having greater power efficiency (e.g., the hybrid CPU).

To enable the process control transition between the main and hybrid processors, the information handling system creates a table that maps devices and processes for controlling the system's power and thermal operations to the more power-efficient hybrid processor. The table is stored in a remappable shared memory space that both the main processor and the hybrid processor can access. Upon sleep mode being triggered, this table can be initialized to seamlessly transition control over processes from the main processor to the hybrid processor. Then, upon terminating sleep mode, the table can be initialized to seamlessly transition control over processes from the hybrid processor to the main processor. Accordingly, the disclosed information handling system provides a power-efficient sleep mode by enabling a more power-efficient processor to control operations in sleep mode, using, for example, dynamic re-mapping described according to aspects of this disclosure.

In some embodiments, an ACPI Firmware Table includes entries with Power Service Objects (PSO) mapped to all devices through Hybrid Core to control power and thermal operation outside of the main SoC. The main CPU may conventionally hold the PSO and device attributes while the information handling system operates in modern standby (MS), such that the main CPU is responsible for MS entry/exit states. In some aspects of this disclosure, to avoid main CPU involvement in pre-boot PEI phase of boot the hybrid CPU is initialized, and the ACPI and thermal switch table is created at a remappable memory region. The Power Service Object (PSO) is allocated, and platform Device Specific Objects (DSO) may be initialized under the PSO table as entries to control independent power control operations. The PSO may be mapped within a remap memory as an extension of the main CPU power table, such that during MS entry/exit a seamless switch may happen from main CPU to hybrid CPU. Using MS-Device attributes, each device in an information handling system may be controlled by the hybrid CPU for a specific power attribute. For example, during MS entry/exit a power attribute may be controlled by the hybrid CPU within MS entry/exit states and the table can be switched between hybrid CPU or main CPU with remap memory table as described in further details below.

PEI may refer to a pre-EFI initialization phase invoked early in a boot flow of an information handling system during which some permanent memory is initialized, memory is described in hand-off blocks, firmware volume locations are described in the hand-off blocks, and control is passed to a driver execution environment (DXE) phase.

DXE may refer to a driver execution environment (DXE) phase that performs further initialization of the information handling system using a DXE Foundation, a DXE Dispatcher, and a set of DXE Drivers. The DXE Dispatcher may discover and execute DXE Drivers in a predetermined order. The DXE Drivers may initialize the main CPU, the hybrid CPU, a chipset, and other system components, and/or may provide software abstractions for system services, console devices, and/or boot devices. These components work together to initialize the system and provide services to boot an operating system. The DXE phase and Boot Device Selection (BDS) phases together establish consoles and attempt the booting of an operating system. The DXE phase may be terminated when an operating system is successfully booted.

According to one embodiment, an information handling system includes a memory; a first processor coupled to the memory; and a second processor coupled to the memory and to the first processor. The first processor may be configured to perform steps comprising: receiving a trigger to initialize sleep mode for the information handling system; and allocating a shared region of the memory to store a switch table, wherein the shared region is shared between the first processor and a second processor. The second processor may be configured to perform steps comprising: transitioning control of a plurality of processes from the first processor to the second processor based on the switch table; and initiating sleep mode for the information handling system.

According to another embodiment, a method may include receiving a trigger to initialize sleep mode of an information handling system; allocating a shared region of a memory to store a switch table, wherein the shared region of the memory is shared between a first processor of the information handling system and a second processor of the information handling system; transitioning control of a plurality of processes from the first processor to the second processor based on the switch table; and initiating sleep mode of the information handling system.

The method may be embedded in a computer-readable medium as computer program code comprising instructions that cause a processor to perform operations corresponding to the steps of the method. In some embodiments, the processor may be part of an information handling system including a first network adaptor configured to transmit data over a first network connection; and a processor coupled to the first network adaptor, and the memory.

As used herein, the term “coupled” means connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially parallel includes parallel), as understood by a person of ordinary skill in the art.

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram of an example system for power-efficient sleep mode according to some embodiments of the disclosure.

FIG. 2 is a block diagram of an example switch table for transitioning process control between a main CPU and a hybrid CPU according to some embodiments of the disclosure.

FIG. 3 is a flow chart of an example method for initiating sleep mode according to some embodiments of the disclosure.

FIG. 4 is a flow chart of an example method for terminating sleep mode according to some embodiments of the disclosure.

FIG. 5 is a schematic block diagram of an example information handling system according to some embodiments of the disclosure.

FIG. 6 is a schematic diagram of a process for entering and exiting sleep mode according to some embodiments of the disclosure.

FIG. 7 is a schematic diagram of memory mapping in the PEI and DXE phases according to some embodiments of the disclosure.

### DETAILED DESCRIPTION

These example embodiments describe and illustrate various methods and information handling systems that improve the power efficiency of an information handling system's sleep mode (e.g., Modern Standby on Microsoft® operating systems). Sleep mode may allow an information handling system to execute battery-draining background activity, such as system updates, messaging, and downloads, which can result in increased operating temperature and/or decreased battery duration for the information handling system. An operating system may also periodically transition the information handling system's main processor from sleep mode to active mode to certain functions, such as an on-demand wake event due to a network interruption, a platform device interruption (e.g., from a source such as the battery fuel gauge, battery charge controller, or thermal sensor), or an interrupt caused by user input (e.g., at a keyboard, touchpad, external USB peripheral, power button, or lid switch). Background and wake-up activities result in higher power consumption than desired during sleep mode—when a user is not actively using the information handling system and thus expects less battery drainage.

The provided information handling system uses two differently-configured processors and transitions certain processes that may be active during sleep mode from execution by a first processor with greater performance capabilities (e.g., a main processor) to a second processor with greater power efficiency (e.g., a hybrid processor) upon triggering sleep mode. The processes can be transitioned back to the main processor upon terminating sleep mode. Transitioning these processes in this way results in reduced battery drainage compared to typical sleep mode since the provided information handling system performs the background and value adding activities in sleep mode using a processor that consumes less power than which is used in a typical system's sleep mode.

To transition the processes between the main and hybrid processors, an information handling system in some aspects of this disclosure creates a shared memory space that both the main processor and the hybrid processor can access. The memory may store a table that maps all devices and processes, to the hybrid processor, for controlling power and thermal operations outside of the main processor can be stored in the shared memory space. This table can be initialized to seamlessly transition control over processes between the main processor and the hybrid processor. Accordingly, the disclosed information handling system provides a more power-efficient sleep mode by enabling a more power-efficient processor to control operations in sleep mode.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

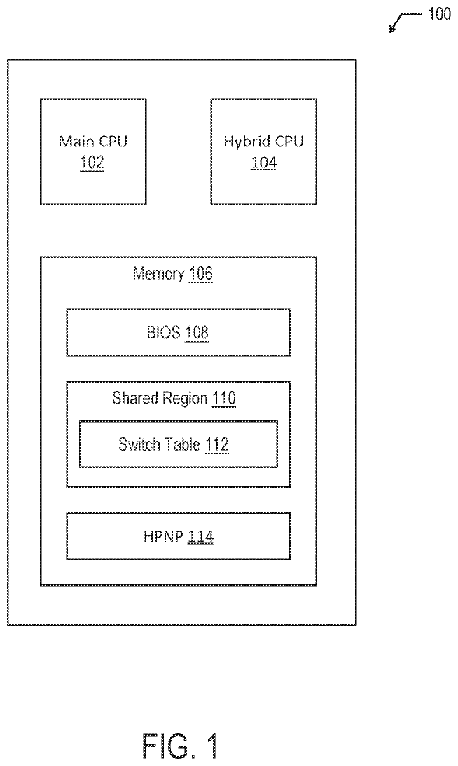

FIG. 1 illustrates a block diagram of an example information handling system 100 for power-efficient sleep mode. The information handling system 100 includes a main processor (e.g., a main central processing unit (CPU)) 102 and a hybrid processor (e.g., a hybrid CPU) 104, which are each in communication with a memory (e.g., a dynamic random-access memory (DRAM)) 106. The main CPU 102 and the hybrid CPU 104 may have a big-little hybrid configuration in which the main CPU 102 is a high-performance processing core and the hybrid CPU 104 is a high-efficiency processing core. Stated differently, the main CPU 102 has greater processing capabilities than the hybrid CPU 104 whereas the hybrid CPU 104 has greater power efficiency than the main CPU 102.

The memory 106 may store firmware that may include a basic input- output system (BIOS) 108. The BIOS 108 may include a configurable setting to enable a hybrid core-based sleep mode, which when enabled configures the information handling system to execute aspects of this disclosure. A portion of the memory 106 may be allocated as a shared region 110 that is shared by both the main CPU 102 and the hybrid CPU 104. The shared region 110 may exist in a memory space of the main CPU 102 and the hybrid CPU 104. In some aspects, the shared region 110 may be stored in a system management random access memory (SMRAM), which is a portion of memory 106 that is accessible in certain operating modes, such as a system management mode (SMM).

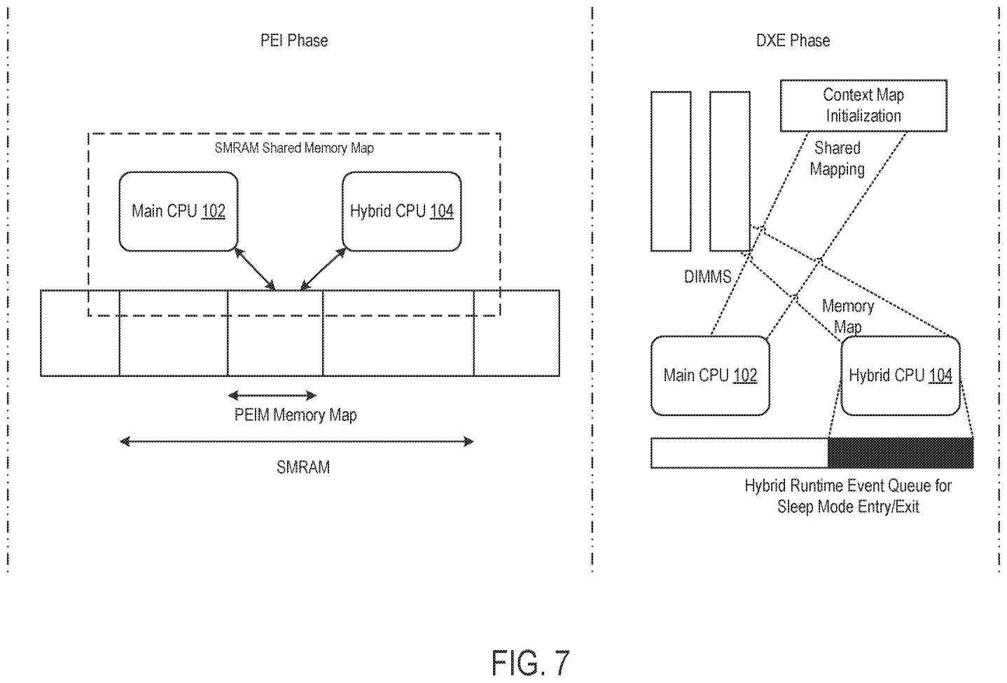

The SMRAM shared memory map may be created and initialized in a PEI phase, in which the hybrid CPU and main CPU may share the events to handle Modern Standby entry/exit functions. During the DXE phase, a Hybrid Runtime Event Queue may be mapped to the hybrid CPU such that task-specific context data may be switched across different cores, to effectively switch the task affinity dynamically. FIG. 7 shows an example schematic diagram of memory mapping in the PEI and DXE phases. Peripherals, such as USB, NIC, storage, and serial, are mapped to main CPU and may be transferred to the hybrid CPU seamlessly through a shared map. The hybrid CPU to embedded controller (EC) communication may be created to support EC functionalities during mobile standby.

Returning to FIG. 1, a switch table 112 may be stored in the remappable shared region 110 for transitioning control of process execution between the main CPU 102 and the hybrid CPU 104. The switch table 112 may be an extension of the power table used by the main CPU 102. The switch table 112 may include entries with Power Service Objects (PSOs) mapped to all devices in the information handling system 100 through the hybrid CPU 104 so that the hybrid CPU 104 can control power and thermal operations outside of the main CPU 102. Device Specific Objects (DSOs) may be initialized as entries in the switch table 112 to control independent power control operations.

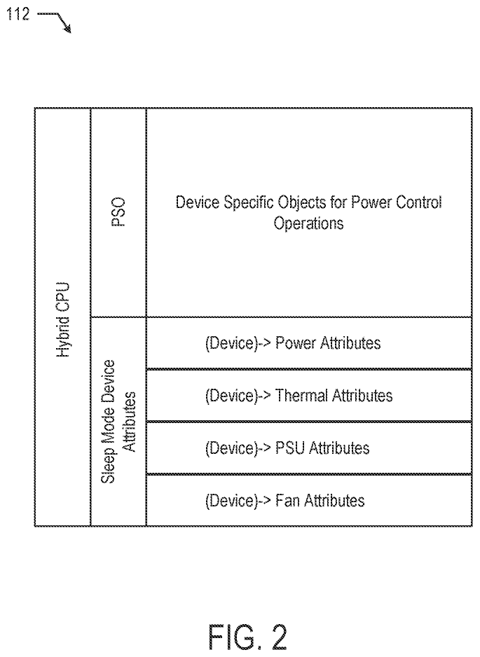

FIG. 2 illustrates a block diagram of an example switch table 112 showing the PSOs and accompanying DSOs. The switch table 112 may also include sleep mode device attributes for each of the devices in the information handling system 100. The attributes for each device in the information handling system 100 may be included in the switch table 112 beyond the example devices that are illustrated. Each device in the information handling system 100 can be controlled by the hybrid CPU 104 for a specific power attribute by way of the switch table 112.

Returning to FIG. 1, the memory 106 may store instructions for a runtime Hybrid-Core Process Namespace Management Protocol (HPNP) 114 that, when executed by a processor (e.g., the main CPU 102 or the hybrid CPU 104), transitions processes between processors (e.g., between the main CPU 102 and the hybrid CPU 104, or vice versa, respectively). In one example, the HPNP 114 offloads, or transitions, all required processes and their context states to the hybrid CPU 104 during entry into sleep mode for power efficiency and restores, or transitions, the processes and their context states back to the main CPU 102 during exit out of sleep mode.

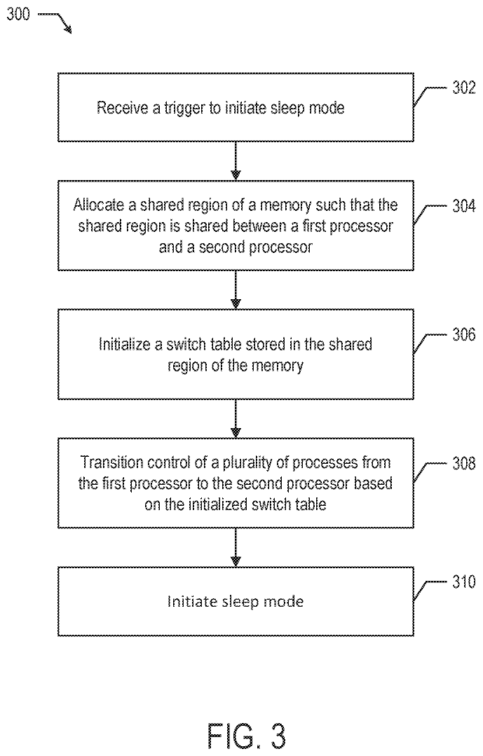

FIG. 3 illustrates a flow chart of an example method 300 for initiating power-efficient sleep mode for an information handling system (e.g., the information handling system 100). At block 302, a trigger to enter sleep mode (e.g., Modern Standby) is received. The trigger may be any suitable combination of parameters that is known in the art to cause an information handling system (e.g., computer) to initiate sleep mode. For example, a user may close the lid of the information handling system 100 thereby triggering sleep mode. In another example, the trigger could be that: (i) all devices outside of the system on a chip (SoC) have been powered down, (ii) all network and radio devices have entered their low-power state to wait for packets matching Wake-on-LAN (WoL) patterns or wake interrupts, (iii) all post-controllers on the SoC have been powered down, (iv) all application background tasks have completed, and/or (v) all CPU and GPU activity has stopped for a predetermined period of time resulting in all processors idling.

At block 304, a shared region (e.g., the shared region 110) of a memory (e.g., the memory 106) is allocated such that the shared region is shared between a first processor (e.g., the main CPU 102) and a second processor (e.g., the hybrid CPU 104). For example, the main CPU 102 may allocate a region of the memory 106 to be the shared region 110 by. In at least some aspects, the shared region 110 of the memory 106 is allocated during memory initialization at the PEI phase of AFCP operation prior to receiving the trigger to initiate sleep mode at block 302. That is, the shared memory region may be allocated at start-up of the information handling system. A hand off block (HOB) may be created with a memory address of the shared region 110. This HOB may then be passed on to the DXE phase from the PEI phase. In the DXE phase, the HOB is located and the hybrid CPU 104 may retrieve the memory address of the shared region 110 from the HOB. The DXE phase is additionally where the runtime event queue for the hybrid CPU 104 is mapped to the hybrid CPU 104 such that task specific context data may be switched from the main CPU 102 to the hybrid CPU 104. Without mapping the runtime event queue for the hybrid CPU 104 to the hybrid CPU 104, the operating system queue cannot understand the capability of runtime event queue since it is created at the DXE phase of platform boot.

At block 306, a switch table (e.g., the switch table 112) stored in the shared region of the memory is initialized. For example, the hybrid CPU 104 may initialize the switch table 112 based on the retrieved memory address of the shared region 110 from the HOB. As described above, the switch table 112 may include entries with Power Service Objects (PSOs) mapped to all devices in the information handling system 100 through the hybrid CPU 104. The switch table 112 may also include sleep mode device attributes (e.g., power, thermal, power supply unit (PSU), fan, CPU, network interface controller (NIC), etc.) for each of the devices in the information handling system 100. The switch table initialization of block 306 may be performed during start-up and/or prior to receiving the trigger to initiate sleep mode at block 302.

At block 308, control of multiple processes is transitioned from the main CPU 102 to the hybrid CPU 104 based on the initialized switch table 112. For example, the hybrid CPU 104 may execute the HPNP 114, which iterates through each of the PSOs in the switch table 112 and enables CPU affinity movements from the main CPU 102 to the hybrid CPU 104 for each of the devices corresponding to the PSOs. In this way, control of the processes performed by these devices is transitioned from the main CPU 102 to the hybrid CPU 104. In various embodiments, the processes for which control is transitioned are those processes that are critical, or otherwise important, to potentially remain active when the information handling system 100 is in sleep mode. In some embodiments, once control is transitioned for each of the processes, Device Specific Objects (DSOs) may be created (e.g., by the hybrid CPU 104) for each of the processes. These DSOs may be handed off to the main CPU 102 during the exit process out of sleep mode as described below. At block 310, sleep mode is initiated. The sleep mode may include activating a low power domain comprising the hybrid CPU 104 and one or more peripherals and de-activating components outside the low power domain. De-activating may refer to de-activating functional portions of the components such that power consumption is reduced, such as by transitioning the main CPU 102 to a deep sleep state and/or decreasing a supply voltage to one or more components (which may include the main CPU 102). The hybrid CPU 104 may initiate sleep mode for the information handling system 100 after control over each of the processes is transitioned to the hybrid CPU 104. While the information handling system 100 is in sleep mode, the hybrid CPU 104 controls all background and functional activities, thus conserving power for the information handling system 100 because the hybrid CPU 104 has greater power efficiency than the main CPU 102.

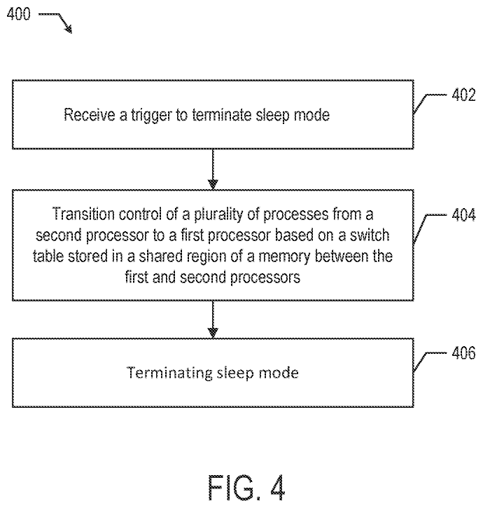

FIG. 4 illustrates a flow chart of an example method 400 for terminating power-efficient sleep mode for an information handling system (e.g., the information handling system 100). At block 402, a trigger to terminate sleep mode is received. The trigger may be any suitable action or combination of parameters that is known in the art to cause an information handling system (e.g., computer) to exit sleep mode. For example, a user may press a power button on the information handling system 100 to wake it up from sleep mode. As another example, criteria may be defined for certain events occurring on the information handling system and/or may be detected by the remaining processes executing on the hybrid CPU during sleep mode that define when the information handling system should terminate sleep mode at block 402.

At block 404, control of a plurality of processes is transitioned from a second processor (e.g., the hybrid CPU 104) to a first processor (e.g., the main CPU 102). The control transition may be based on a switch table (e.g., the switch table 112) stored in a shared region (e.g., the shared region 110) of a memory, in which the shared region is shared between the hybrid CPU 104 and the main CPU 102. For example, the hybrid CPU 104 may execute the HPNP 114, which iterates through each of the PSOs in the switch table 112 and enables CPU affinity movements from the hybrid CPU 104 to the main CPU 102 for each of the devices corresponding to the PSOs. In at least some embodiments, Device Specific Objects (DSOs) created (e.g., by the hybrid CPU 104) for each of the processes may be handed off to the main CPU 102 during the transition out of sleep mode. In this way, control of the processes performed by these devices is transitioned from the hybrid CPU 104 to the main CPU 102. In various embodiments, the processes for which control is transitioned are those processes that are critical, otherwise important, or specified by a user to potentially remain active when the information handling system 100 is in sleep mode. At block 406, sleep mode is terminated. Terminating sleep mode may involve restoring supply voltage, increase supply voltage, and/or changing a sleep state of the main CPU 102 and/or other components. For example, an active mode of the information handling system 100 is restored upon sleep mode being terminated.

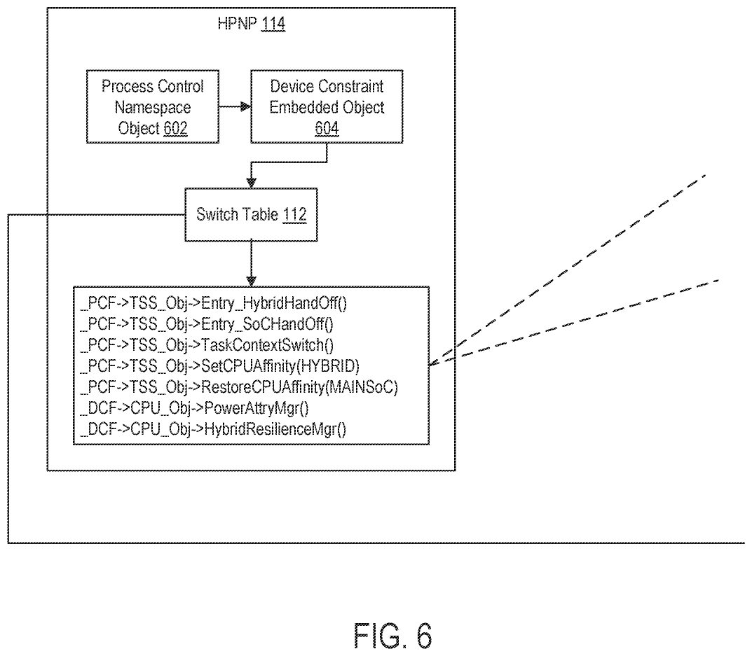

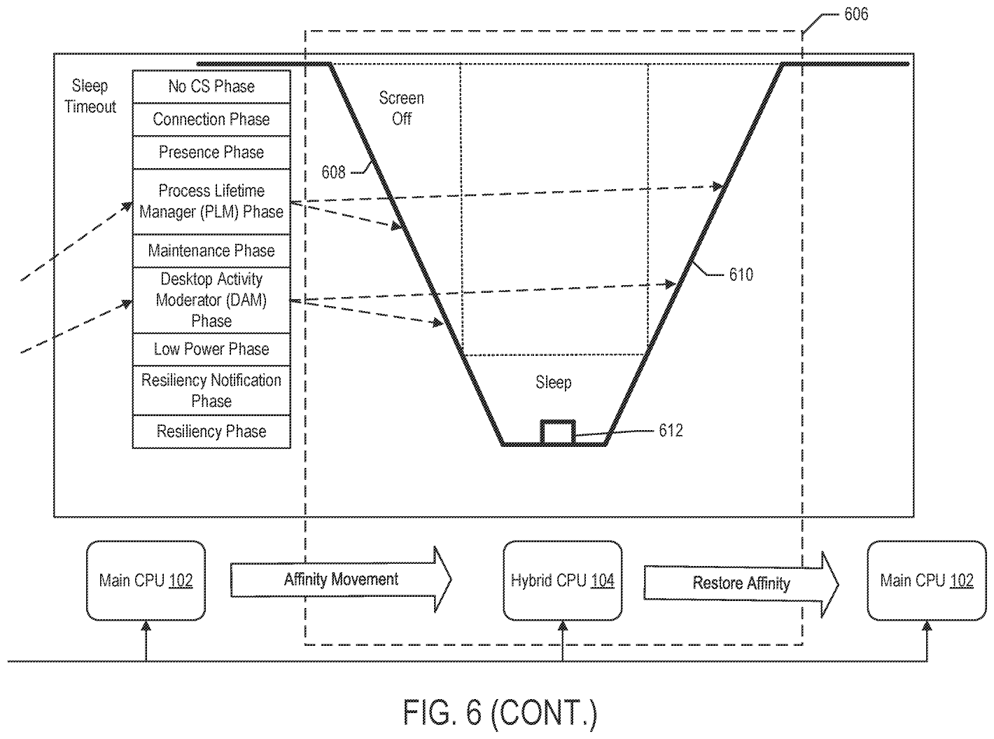

FIG. 6 illustrates a schematic diagram of an example process for entering and exiting sleep mode. As described above, the HPNP 114 iterates through each of the PSOs (e.g., process control namespace objects 602) in the switch table 112 and enables CPU affinity movements from the main CPU 102 to the hybrid CPU 104, and affinity restoration from the hybrid CPU 104 to the main CPU 102, for each of the devices corresponding to the PSOs. In some embodiments, once control is transitioned for each of the processes, Device Specific Objects (DSOs) (e.g., device constraint embedded objects 604) may be created for each of the processes.

A power efficient hybrid domain 606 is shown within which the information handling system 100 enters sleep mode on the downward sloping line 608 and exits sleep mode on the upward sloping line 610. The screen of the information handling system 100 may be off when the information handling system 100 is entering sleep mode. Each of the phases are shown as the information handling system 100 enters sleep mode, though it will be appreciated that the size of the box of each phase is not indicative of the relative time in each phase. Control of each of the processes for sleep mode is transitioned from the main CPU 102 to the hybrid CPU 104 in the power efficient hybrid domain 606. When the information handling system 100 is in sleep mode, a value-adding software activity 612 may be performed.

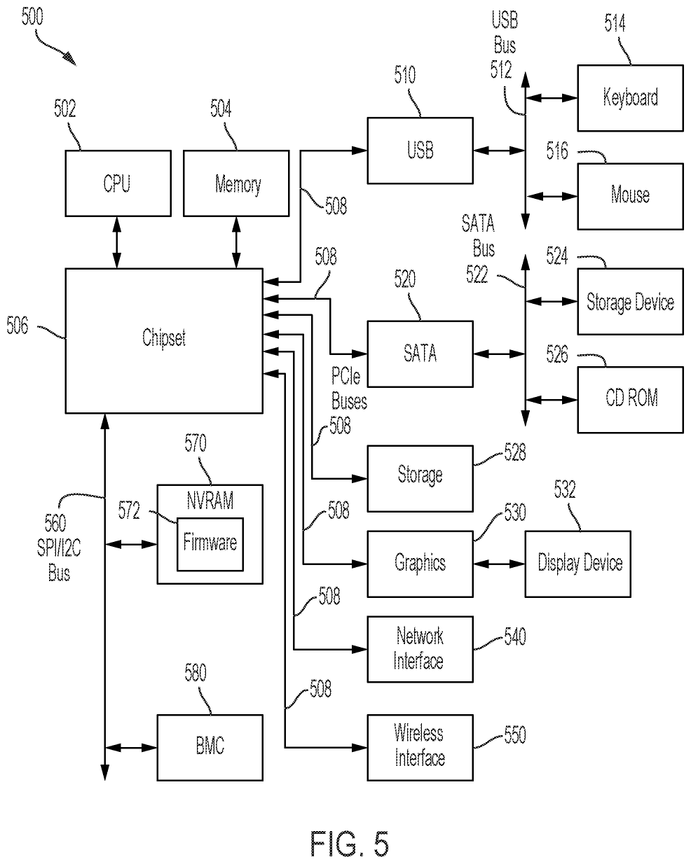

FIG. 5 illustrates an example information handling system 500. The information handling system 500 illustrates various components of an information handling system that were not illustrated for the information handling system 100. It will be appreciated that any of the components of the information handling system 500 may be included with the information handling system 100 and vice versa. Information handling system 500 may include a processor 502 (e.g., a central processing unit (CPU)), a memory (e.g., a dynamic random-access memory (DRAM)) 504, and a chipset 506. In some embodiments, one or more of the processor 502, the memory 504, and the chipset 506 may be included on a motherboard (also referred to as a mainboard), which is a printed circuit board (PCB) with embedded conductors organized as transmission lines between the processor 502, the memory 504, the chipset 506, and/or other components of the information handling system. The components may be coupled to the motherboard through packaging connections such as a pin grid array (PGA), ball grid array (BGA), land grid array (LGA), surface-mount technology, and/or through-hole technology. In some embodiments, one or more of the processor 502, the memory 504, the chipset 506, and/or other components may be organized as a System on Chip (SoC).

The processor 502 may execute program code by accessing instructions loaded into memory 504 from a storage device, executing the instructions to operate on data also loaded into memory 504 from a storage device, and generate output data that is stored back into memory 504 or sent to another component. The processor 502 may include processing cores capable of implementing any of a variety of instruction set architectures (ISAs), such as the x86, POWERPC®, ARM®, SPARC®, or MIPS® ISAs, or any other suitable ISA. The provided information handling system 500 is a multi-processor system in which each of the processors 502 may commonly, but not necessarily, implement the same ISA. At least some of the multiple processors are present in a big-little hybrid configuration with at least one high-performance processing core and at least one high-efficiency processing core. The chipset 506 may facilitate the transfer of data between the processors 502, the memory 504, and other components. In some embodiments, chipset 506 may include two or more integrated circuits (ICs), such as a northbridge controller coupled to the processor 502, the memory 504, and a southbridge controller, with the southbridge controller coupled to the other components such as USB 550, SATA 520, and PCIe buses 508. The chipset 506 may couple to other components through one or more PCIe buses 508.

Some components may be coupled to one bus line of the PCIe buses 508, whereas some components may be coupled to more than one bus line of the PCIe buses 508. One example component is a universal serial bus (USB) controller 550, which interfaces the chipset 506 to a USB bus 512. A USB bus 512 may couple input/output components such as a keyboard 514 and a mouse 516, but also other components such as USB flash drives, or another information handling system. Another example component is a SATA bus controller 520, which couples the chipset 506 to a SATA bus 522. The SATA bus 522 may facilitate efficient transfer of data between the chipset 506 and components coupled to the chipset 506 and a storage device 524 (e.g., a hard disk drive (HDD) or solid-state disk drive (SDD)) and/or a compact disc read-only memory (CD-ROM) 526. The PCIe bus 508 may also couple the chipset 506 directly to a storage device 528 (e.g., a solid-state disk drive (SDD)). A further example of an example component is a graphics device 530 (e.g., a graphics processing unit (GPU)) for generating output to a display device 532, a network interface controller (NIC) 540, and/or a wireless interface 550 (e.g., a wireless local area network (WLAN) or wireless wide area network (WWAN) device) such as a Wi-Fi® network interface, a Bluetooth® network interface, a GSM® network interface, a 3G network interface, a 4G LTE® network interface, and/or a 5G NR network interface (including sub-6 GHz and/or mmWave interfaces). In one example embodiment, chipset 506 may be directly connected to an individual end point via a PCIe root port within the chipset and a point-to-point topology as shown in FIG. 1.

The chipset 506 may also be coupled to a serial peripheral interface (SPI) and/or Inter-Integrated Circuit (I2C) bus 560, which couples the chipset 506 to system management components. For example, a non-volatile random-access memory (NVRAM) 570 for storing firmware 572 may be coupled to the bus 560. As another example, a controller, such as a baseboard management controller (BMC) 580, may be coupled to the chipset 506 through the bus 560. BMC 580 may be referred to as a service processor or embedded controller (EC). Capabilities and functions provided by BMC 580 may vary considerably based on the type of information handling system. For example, the term baseboard management system may be used to describe an embedded processor included at a server, while an embedded controller may be found in a consumer-level device. As disclosed herein, BMC 580 represents a processing device different from processor 502, which provides various management functions for information handling system 500. For example, an embedded controller may be responsible for power management, cooling management, and the like. An embedded controller included at a data storage system may be referred to as a storage enclosure processor or a chassis processor.

System 500 may include additional processors that are configured to provide localized or specific control functions, such as a battery management controller. Bus 560 can include one or more busses, including a Serial Peripheral Interface (SPI) bus, an Inter-Integrated Circuit (I2C) bus, a system management bus (SMBUS), a power management bus (PMBUS), or the like. BMC 580 may be configured to provide out-of-band access to devices at information handling system 500. Out-of-band access in the context of the bus 560 may refer to operations performed prior to execution of firmware 572 by processor 502 to initialize operation of system 500.

Firmware 572 may include instructions executable by processor 502 to initialize and test the hardware components of system 500. For example, the instructions may cause the processor 502 to execute a power-on self-test (POST). The instructions may further cause the processor 502 to load a boot loader or an operating system (OS) from a mass storage device. Firmware 572 additionally may provide an abstraction layer for the hardware, such as a consistent way for application programs and operating systems to interact with the keyboard, display, and other input/output devices. When power is first applied to information handling system 500, the system may begin a sequence of initialization procedures, such as a boot procedure or a secure boot procedure. During the initialization sequence, also referred to as a boot sequence, components of system 500 may be configured and enabled for operation and device drivers may be installed. Device drivers may provide an interface through which other components of the system 500 can communicate with a corresponding device. The firmware 572 may include a basic input-output system (BIOS) and/or include a unified extensible firmware interface (UEFI). Firmware 572 may also include one or more firmware modules of the information handling system. Additionally, configuration settings for the firmware 572 and firmware of the information handling system 500 may be stored in the NVRAM 570. NVRAM 570 may, for example, be a non-volatile firmware memory of the information handling system 500 and may store a firmware memory map namespace 500 of the information handling system. NVRAM 570 may further store one or more container-specific firmware memory map namespaces for one or more containers concurrently executed by the information handling system.

Information handling system 500 may include additional components and additional busses, not shown for clarity. For example, system 500 may include multiple processor cores (either within processor 502 or separately coupled to the chipset 506 or through the PCIe buses 508), audio devices (such as may be coupled to the chipset 506 through one of the PCIe busses 508), or the like. While a particular arrangement of bus technologies and interconnections is illustrated for the purpose of example, one of skill will appreciate that the techniques disclosed herein are applicable to other system architectures. System 500 may include multiple processors and/or redundant bus controllers. In some embodiments, one or more components may be integrated together in an integrated circuit (IC), which is circuitry built on a common substrate. For example, portions of chipset 506 can be integrated within processor 502. Additional components of information handling system 500 may include one or more storage devices that may store machine-executable code, one or more communications ports for communicating with external devices, and various input and output (I/O) devices, such as a keyboard, a mouse, and a video display.

In some embodiments, processor 502 may include multiple processors, such as multiple processing cores for parallel processing by the information handling system 500. For example, the information handling system 500 may include a server comprising multiple processors for parallel processing. In some embodiments, the information handling system 500 may support virtual machine (VM) operation, with multiple virtualized instances of one or more operating systems executed in parallel by the information handling system 500. For example, resources, such as processors or processing cores of the information handling system may be assigned to multiple containerized instances of one or more operating systems of the information handling system 500 executed in parallel. A container may, for example, be a virtual machine executed by the information handling system 500 for execution of an instance of an operating system by the information handling system 500. Thus, for example, multiple users may remotely connect to the information handling system 500, such as in a cloud computing configuration, to utilize resources of the information handling system 500, such as memory, processors, and other hardware, firmware, and software capabilities of the information handling system 500. Parallel execution of multiple containers by the information handling system 500 may allow the information handling system 500 to execute tasks for multiple users in parallel secure virtual environments.

The schematic flow charts of FIGS. 2 and 3 are generally set forth as logical flow chart diagrams. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, methods and steps described in the specification. For example, although processors are described throughout the detailed description, aspects of the invention may be applied to the design of or implemented on different kinds of processors, such as graphics processing units (GPUs), central processing units (CPUs), and digital signal processors (DSPs). As another example, although processing of certain kinds of data may be described in example embodiments, other kinds or types of data may be processed through the methods and devices described above. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. An information handling system, comprising:
a memory;
a first processor coupled to the memory; and
a second processor coupled to the memory and to the first processor,
wherein the first processor is configured to perform steps comprising:
receiving a trigger to initialize sleep mode for the information handling system; and
allocating a shared region of the memory to store a switch table, wherein the shared region is shared between the first processor and a second processor, and
the second processor is configured to perform steps comprising:
transitioning control of a plurality of processes from the first processor to the second processor based on the switch table; and
initiating sleep mode for the information handling system.

2. The information handling system of claim 1, wherein the first processor comprises a first configuration with more processing capabilities than a second configuration of the second processor.

3. The information handling system of claim 1, wherein sleep mode is Modern Standby.

4. The information handling system of claim 1,
wherein the second processor is further configured to perform the steps comprising:
receiving a trigger to exit sleep mode; and
transitioning the transitioned processes from the second processor to the first processor based on the initialized switch table.

5. The information handling system of claim 1, wherein the shared region of the memory is in system management random access memory (SMRAM).

6. The information handling system of claim 1, wherein:
the first processor is configured to perform the step of allocating a shared region of the memory by performing steps at a start-up of the information handling system comprising:
during a pre-EFI initialization (PEI) phase, allocating the shared region of the memory;
during the PEI phase, creating a hand-off block (HOB) comprising a memory address pointing to the shared region;
during a driver execution environment (DXE) phase, creating the switch table at the memory addresses in the hand-off block (HOB), the switch table comprising one or more PSO objects.

7. A method, comprising:
receiving a trigger to initialize sleep mode of an information handling system;
allocating a shared region of a memory to store a switch table, wherein the shared region of the memory is shared between a first processor of the information handling system and a second processor of the information handling system;
transitioning control of a plurality of processes from the first processor to the second processor based on the switch table; and
initiating sleep mode of the information handling system.

8. The method of claim 7, wherein the shared region of the memory is allocated during memory initialization at a pre-EFI initialization (PEI) phase, the method further comprising, during the PEI phase generating a hand-off block (HOB) comprising a memory address pointing to the shared region.

9. The method of claim 8, further comprising initializing the switch table, during a driver execution environment (DXE) phase, the hand-off block (HOB) created during the PEI phase, wherein the switch table is initialized with at least one power service object (PSO).

10. The method of claim 9, wherein transitioning control of the plurality of processes from the first processor to the second processor comprises changing a processor affinity of each of the at least one power service object (PSO) in the switch table from the first processor to the second processor.

11. The method of claim 7, wherein the first processor comprises a first configuration with more processing capabilities than a second configuration of the second processor.

12. The method of claim 7, wherein the sleep mode is Modern Standby.

13. The method of claim 7, wherein the shared region of the memory is in system management random access memory (SMRAM).

14. The method of claim 7, further comprising:
receiving a trigger to terminate the sleep mode;
transitioning control of a plurality of processes from the second processor to the first processor based on the switch table; and
terminating the sleep mode.

15. A computer program product, comprising:
a non-transitory computer readable medium comprising code for performing steps comprising:
receiving a trigger to initialize sleep mode of an information handling system;
allocating a shared region of a memory to store a switch table, wherein the shared region of the memory is shared between a first processor of the information handling system and a second processor of the information handling system;
transitioning control of a plurality of processes from the first processor to the second processor based on the switch table; and
initiating sleep mode of the information handling system.

16. The computer program product of claim 15, wherein the shared region of the memory is allocated during memory initialization at a pre-EFI initialization (PEI) phase, the method further comprising, during the PEI phase generating a hand-off block (HOB) comprising a memory address pointing to the shared region.

17. The computer program product of claim 16, wherein the steps further comprise initializing the switch table, during a driver execution environment (DXE) phase, the hand-off block (HOB) created during the PEI phase, wherein the switch table is initialized with at least one power service object (PSO).

18. The computer program product of claim 17, wherein transitioning control of the plurality of processes from the first processor to the second processor comprises changing a processor affinity of each of the at least one power service object (PSO) in the switch table from the first processor to the second processor.

19. The computer program product of claim 15, wherein the shared region of the memory is in system management random access memory (SMRAM).

20. The computer program product of claim 15, wherein the steps further comprise:
receiving a trigger to terminate the sleep mode;
transitioning control of a plurality of processes from the second processor to the first processor based on the switch table; and
terminating the sleep mode.
